(19) United States
(12) Patent Application Publication
(10) Pub. No.: US 2015/0278886 A1
(43) Pub. Date: Oct. 1, 2015

(54) METHODS AND SYSTEMS FOR PROVIDING PRICING INFORMATION FOR ORDERING A VEHICLE THROUGH A VEHICLE DEALERSHIP

(71) Applicant: Fusz Digital Ltd., Tortola (GB)

(72) Inventor: Eugene A. Fusz, Palm Beach, FL (US)

(21) Appl. No.: 14/224,909

(22) Filed: Mar. 25, 2014

(51) Int. Cl. G06Q 30/02; G06Q 30/06

(52) U.S. Cl. CPC G06Q 30/0283; G06Q 30/0633

(57) ABSTRACT

A method for providing pricing information for ordering a vehicle is provided. The method is performed by a server computing device. The method includes receiving, by the server computing device, pricing information including an identification of the vehicle and a price at which a vehicle dealership offers to order and deliver the vehicle. The method also includes receiving, by the server computing device, from a client computing device associated with a consumer, a pricing request including the identification of the vehicle, and transmitting the price for the vehicle to the client computing device while withholding an identity of the vehicle dealership.

### BACKGROUND

This invention relates generally to providing pricing information for a vehicle, and more specifically to providing pricing information for ordering a vehicle through a vehicle ordering dealership.

Known systems for providing vehicle pricing information provide such information for one or more vehicles that are in stock at a dealership or other seller. Other known systems provide a manufacturer's suggested retail price (MSRP) for one or more vehicles. In some instances, a vehicle dealership may associate a modified MSRP with a vehicle. The modified MSRP includes additional fees charged by the vehicle dealership to sell the vehicle to a consumer. Some known systems provide an invoice price available to dealerships or vehicle fleet operators when ordering one or more vehicles from a manufacturer. Generally, invoice prices available to vehicle dealerships and fleet operators are less than prices available to individual consumers. In some instances, an invoice price may be modified to include advertising costs incurred by a vehicle dealership or an association of vehicle dealerships. Additionally, in some instances, a manufacturer pays a fee known as a “holdback” to a vehicle dealership when the dealership sells a vehicle. Accordingly, an invoice price may not accurately reflect the cost of the vehicle to the vehicle dealership. Further, in some instances, an advertised price for a vehicles does not include fees for financing and/or features (“options”) installed by a vehicle dealership, which the vehicle dealership may require as part of the sale of the vehicle.

Accordingly, in known systems, an individual consumer does not have convenient access to final prices at which local vehicle dealerships (“vehicle ordering dealerships”) would be willing to order and deliver a vehicle on behalf of the consumer. Accordingly, it may be difficult for the consumer to determine how a price offered by a first vehicle dealership in the local market compares to one or more other prices that one or more other vehicle ordering dealerships in the local market would agree to for ordering and delivering the same vehicle to the consumer.

### BRIEF DESCRIPTION

In one aspect, a method for providing pricing information for ordering a vehicle is provided. The method is performed by a server computing device. The method includes receiving, by the server computing device, pricing information including an identification of the vehicle and a price at which a vehicle dealership offers to order and deliver the vehicle. The method also includes receiving, by the server computing device, from a client computing device associated with a consumer, a pricing request including the identification of the vehicle, and transmitting the price for the vehicle to the client computing device while withholding an identity of the vehicle dealership.

In another aspect, a server computing device for providing pricing information for ordering a vehicle is provided. The server computing device is configured to receive pricing information including an identification of the vehicle and a price at which a vehicle dealership offers to order and deliver the vehicle, receive, from a client computing device associated with a consumer, a pricing request including the identification of the vehicle, and transmit the price for the vehicle to the client computing device while withholding an identity of the vehicle dealership.

In another aspect, a computer-readable storage device having processor-executable instructions embodied thereon is provided. The processor-executable instructions are for providing pricing information for ordering a vehicle. When executed by a server computing device, the processor-executable instructions cause the server computing device to receive pricing information including an identification of the vehicle and a price at which a vehicle dealership offers to order and deliver the vehicle, receive, from a client computing device associated with a consumer, a pricing request including the identification of the vehicle, and transmit the price for the vehicle to the client computing device while withholding an identity of the vehicle dealership.

### BRIEF DESCRIPTION OF THE DRAWINGS

FIG. 1 is a schematic diagram illustrating an example environment including a consumer and a plurality of vehicle dealerships.

FIG. 2 is a simplified block diagram of a pricing information system including a plurality of computing devices in accordance with one example embodiment of the present disclosure.

FIG. 3 is an expanded block diagram of a server architecture of the pricing information system, including the plurality of computing devices, in accordance with one example embodiment of the present disclosure.

FIG. 4 illustrates an example configuration of a client computing device shown in FIGS. 1-3.

FIG. 5 illustrates an example configuration of a server computing device shown in FIGS. 1-3.

FIG. 6 is a flowchart of an example process that may be performed by one or more computing devices of the pricing information system for providing pricing information for ordering a vehicle through a vehicle dealership.

FIG. 7 is a diagram of components of one or more example computing devices that may be used in the pricing information system of FIGS. 1-3.

### DETAILED DESCRIPTION OF THE INVENTION

Embodiments of methods and systems described herein provide pricing information for ordering a vehicle through a vehicle ordering dealership. More specifically, systems described herein receive pricing information from at least one vehicle dealership within a local market (e.g., a predetermined geographic area) of a consumer. In some implementations, the pricing information pertains to a price that the vehicle ordering dealership offers to charge for the service of ordering a vehicle from the vehicle's manufacturer and providing the vehicle to the consumer. In some implementations, the vehicle ordering dealership may have the vehicle in stock, but is willing to order the same vehicle (i.e., a vehicle having the same make, model, and features) from the manufacturer and deliver it to the customer. In yet other implementations, the vehicle ordering dealership has the vehicle in stock and offers to sell the in-stock vehicle at the price for ordering and delivering the vehicle to the consumer. In some implementations, the pricing information is expressed as a (i) monetary amount or percentage relative to (ii) a dealer invoice charged by the manufacturer or an MSRP. For example, the vehicle ordering dealership may agree to order the vehicle and provide it to the consumer for $100 more than the dealer invoice. As another example, the pricing information is expressed as the MSRP (e.g. $40,000) minus a percentage, (e.g., 10%). Different vehicle ordering dealerships in the local market may submit different pricing information (i.e., bids), such that for a particular vehicle, or for all vehicles, one of the vehicle ordering dealerships offers to charge a lower price than the other vehicle ordering dealerships. Accordingly, and as described in more detail herein, at least one implementation of the system serves as an anonymous reverse auction for the ordering and delivering of vehicles by vehicle ordering dealerships in a local market.

Implementations of systems described herein transmit the lowest price to the consumer and, initially, withhold an identity of the vehicle ordering dealership associated with the lowest price. Such pricing information enables the consumer to negotiate with one or more vehicle dealerships more effectively than the consumer may otherwise be able to negotiate. More specifically, with the knowledge of a specific price at which a vehicle ordering dealership is willing to charge to order and deliver a particular vehicle to the consumer, the consumer is able to evaluate whether other prices offered to the consumer for the vehicle are more favorable or less favorable to the consumer. Additionally, in at least some implementations, the system informs the consumer of how the pricing information relates to the dealer invoice or MSRP, to further enable the consumer to evaluate whether the pricing information is favorable to the consumer. In some implementations, the system receives payment information from the consumer for a fee to be charged by the system to reveal the pricing information from the lowest bidding vehicle ordering dealership.

In some implementations, the system additionally facilitates ordering the vehicle through the lowest bidding vehicle ordering dealership. For example, the system receives additional payment information from the consumer for payment of a deposit. The system then transmits the identity of the lowest bidding vehicle ordering dealership to the consumer and transmits a notification to the lowest bidding vehicle ordering dealership that the deposit has been collected from the consumer and will be paid to the vehicle ordering dealership for ordering and delivering the vehicle to the consumer. In some implementations, the system transmits the deposit (e.g., payment information) to the lowest bidding vehicle ordering dealership when the lowest bidding vehicle ordering dealership performs (e.g., orders the vehicle and delivers it to the consumer). In other implementations, the system transmits the deposit to the vehicle ordering dealership at another point in time, for example, before the vehicle ordering dealership orders the vehicle.

The methods and systems described herein may be implemented using computer programming or engineering techniques including computer software, firmware, hardware or any combination or subset thereof, wherein the technical effect may include at least one of: (a) receiving, by a server computing device, pricing information including an identification of a vehicle and a price at which a vehicle dealership offers to order and deliver the vehicle; (b) receiving, by the server computing device, from a client computing device associated with a consumer, a pricing request including the identification of the vehicle; and (c) transmitting the price for the vehicle to the client computing device while withholding an identity of the vehicle dealership.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to providing pricing information for a vehicle.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

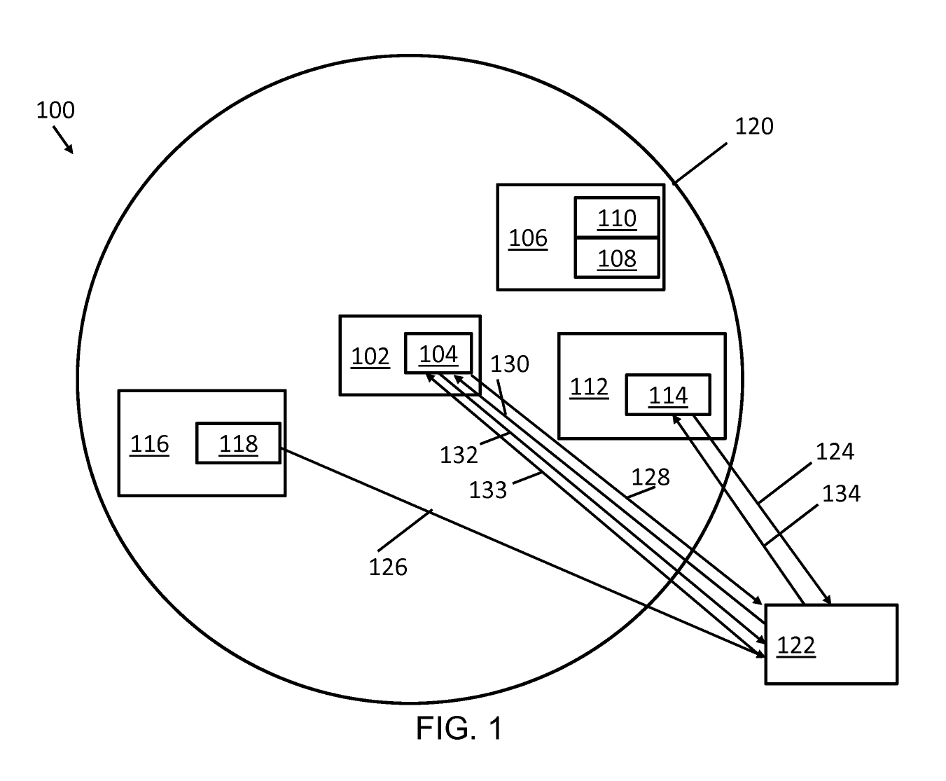

FIG. 1 is a schematic diagram illustrating an environment 100 including a consumer 102 associated with a client computing device 104. Environment 100 additionally includes a vehicle dealership 106 associated with an identification 107 (e.g., name, address, phone number, and/or other contact information). Additionally, vehicle dealership 106 has a client computing device 108 and a vehicle 110 that is in stock. Vehicle 110 is associated with an identification 111 (e.g., make, model, and features, and/or a vehicle identification number (VIN)). Additionally, environment 100 includes a second vehicle dealership 112 (i.e., a vehicle ordering dealership). Second vehicle dealership 112 is associated with an identification 113 (e.g., name, address, phone number, and/or other contact information). Second vehicle dealership 112 is also associated with a client computing device 114. Further, environment 100 includes a third vehicle dealership 116 (i.e., a vehicle ordering dealership), which has an associated identification 117 (e.g., name, address, phone number, and/or other contact information) and a client computing device 118. Consumer 102, vehicle dealership 106, second vehicle dealership 112, and third vehicle dealership 116 are within a local market 120. More specifically, local market 120 may be a particular zip code, a predefined range of consumer 102, or other geographical area. Consumer 102 may visit vehicle dealership 106 and, upon viewing vehicle 110, determine that consumer 102 would like to purchase vehicle 110. Consumer 102 may discuss a price for vehicle 110 with vehicle dealership 106.

A server system 122 operates a reverse auction by receiving pricing information (“bids”) from vehicle dealerships (e.g., second vehicle dealership 112 and third vehicle dealership 116) and determining a lowest price among the bids for a vehicle (e.g., vehicle 110). Within the context of this description, references to vehicle 110 means any vehicle having the same make, model, and features (“options”) as vehicle 110. Computing device 114 transmits pricing information to server system 122, which, in some implementations, is remotely located from local market 120. More specifically, pricing information 124 includes identification 111 of vehicle 110 and a price at which second vehicle dealership 112 offers to order vehicle 110 and deliver vehicle 110 to a consumer (e.g., consumer 102). Additionally, client computing device 118 transmits pricing information 126 to server system 122. More specifically, pricing information 126 includes identification 111 of vehicle 110 and a price at which third dealership 116 offers to order vehicle 110 and deliver vehicle 110 to a consumer (e.g., consumer 102). In some implementations, server system 122 receives pricing information 124 and pricing information 126 before consumer 102 visits any of vehicle dealerships 106, 112, and 116.

In order to determine how the price from vehicle dealership 106 for vehicle 110 compares with other prices in local market 120, such as from vehicle dealerships 112 and 116, consumer 102 causes client computing device 104 to transmit a pricing request 128 to server system 122. Pricing request 128 includes identification 111 of vehicle 110. In implementations in which identification 111 is a vehicle identification number (VIN), server system 122 uses the VIN to retrieve make, model, and features information from a database (e.g., database 206) for vehicle 110. In response, server system 122 transmits a response 130 to client computing device 104 including the lowest price from pricing information 124 and pricing information 126. Importantly, in some implementations, pricing request 128 additionally includes payment information, for payment of a fee for providing the pricing information to client computing device 104. In other words, server system 122 may charge a fee from consumer 102 to provide the lowest price (i.e., the lowest bid) for vehicle 110 in local market 120. In some implementations, server system 122 receives the payment information for the fee separately from (i.e., before) receiving pricing request 128. In some implementations, local market 120 includes a different number of vehicle dealerships than shown in FIG. 1. Additionally, in some implementations, server system 122 receives pricing information from only one vehicle dealership (e.g., only vehicle dealership 112), or more than two vehicle dealerships.

Consumer 102 evaluates the price included in response 130 and decides to purchase vehicle 110 at the price specified in response 130. Accordingly, consumer 102 causes client computing device 104 to transmit a communication 132 to server system 122, including an indication that consumer 102 wishes to purchase vehicle 110 at the specified price. Communication 132 includes payment information for a deposit (e.g., $1000) on the price of vehicle 110. In response, server system 122 transmits a communication 133 to client computing device 104 including identity 113 of vehicle dealership 112. Additionally, server system 122 transmits a communication 134 to client computing device 114 including an instruction to proceed with ordering vehicle 110 from the manufacturer and to deliver vehicle 110 to consumer 102. Additionally, communication 134 includes a notification that the deposit has been collected and at least a portion of the deposit will be provided to vehicle dealership 112. In some implementations, communication 134 includes payment information for the deposit, enabling vehicle dealership 112 to collect at least a portion of the deposit prior to ordering vehicle 110. In some implementations, server system 122 allocates a portion of the deposit to payment of a fee for transmitting the identification of vehicle dealership 112 to client computing device 104.

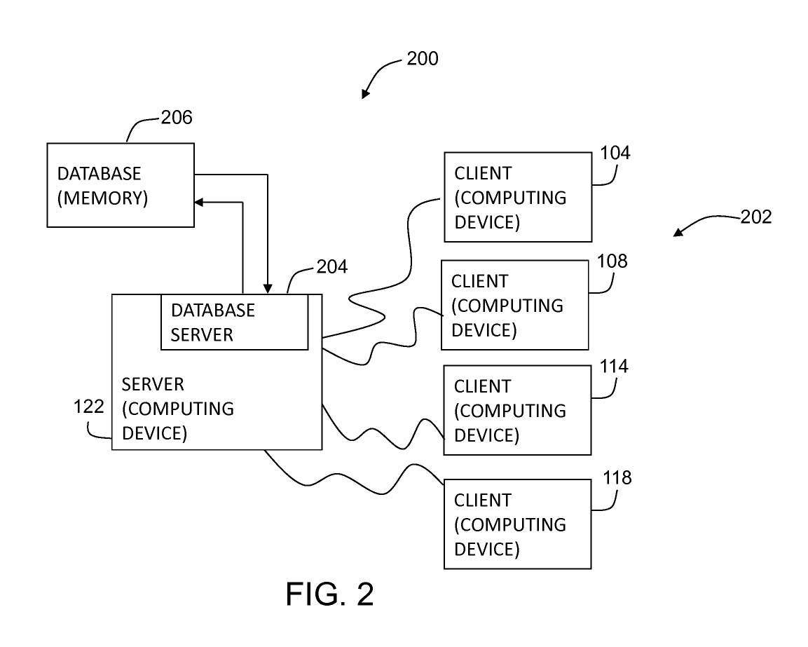

FIG. 2 is a simplified block diagram of an example pricing information system 200. Pricing information system 200 includes server system 122 (also referred to herein as “server computing device”) and a plurality of client computing devices 202, in communication with server system 122. In one embodiment, client computing devices 202 are computers including a web browser, such that server system 122 is accessible to client computing devices 202 using the Internet. Client computing devices 202 include, for example, client computing device 104, client computing device 108, client computing device 114, and client computing device 118. Client computing devices 202 are connected to the Internet through many interfaces including a network, such as a local area network (LAN) and/or a wide area network (WAN), dial-in connections, cable modems, wireless-connections, and/or high-speed ISDN lines. Each of client computing devices 202 may be any device capable of interconnecting to the Internet including a web-based phone, personal digital assistant (PDA), or other web-connectable equipment. A database server 204 is connected to a database 206 that contains information on a variety of matters, as described below in greater detail. In one embodiment, database 206 is stored on server system 122 and data stored in database 206 may be received from and/or provided to one or more of client computing devices 202 by server system 122. In any alternative embodiment, database 206 is stored remotely from server system 122 and may be non-centralized. Server system 122 could be any type of computing device configured to perform the steps described herein. As discussed below, pricing information, vehicle information, dealership information, and payment information is stored in database 206.

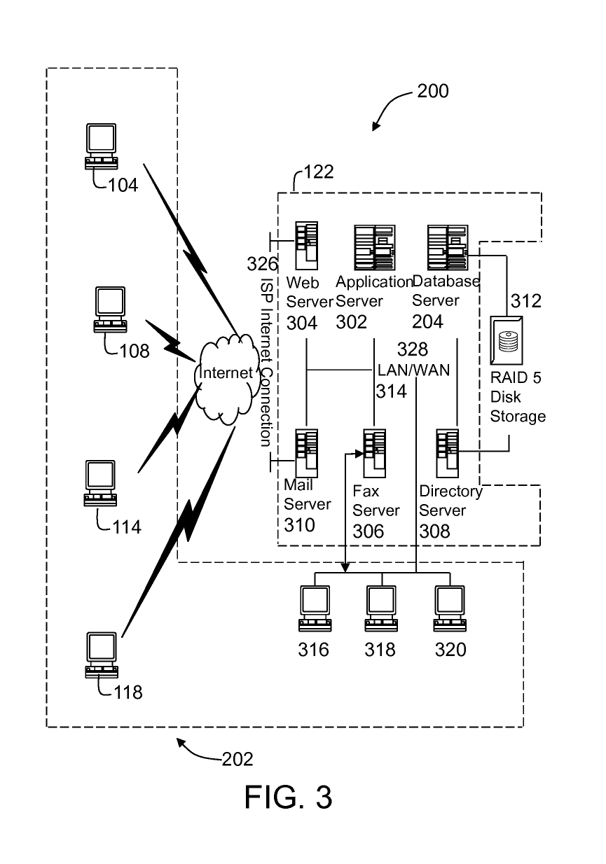

FIG. 3 is an expanded block diagram of a server architecture of pricing information system 200 in accordance with one embodiment of the present disclosure. Pricing information system 200 includes server system 122 and client computing devices 202. Server system 122 further includes database server 204, an application server 302, a web server 304, a fax server 306, a directory server 308, and a mail server 310. A disk storage unit 312 is coupled to database server 204 and directory server 308. Servers 204, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 122 is configured to be communicatively coupled to various computing devices, including client computing devices 104, 108, 114, and 118, using, for example, an Internet connection 326 as described above. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

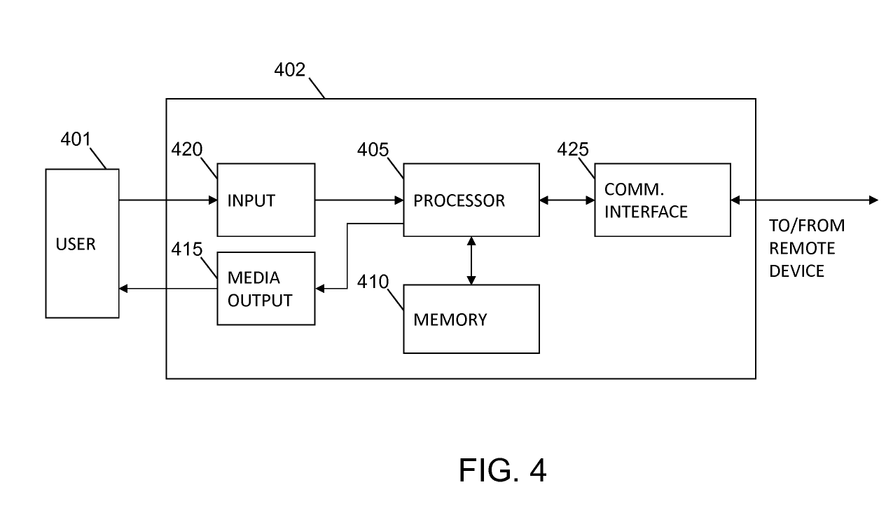

FIG. 4 illustrates an example configuration of a client computing device 402. Client computing device 402 may include, but is not limited to, client computing devices 104, 108, 114, 118, and workstations 316, 318, and 320 (shown in FIG. 3).

Client computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Client computing device 402 also includes at least one media output component 415 for presenting information to a user 401. Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 420 for receiving input from user 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Client computing device 402 may also include a communication interface 425, which is communicatively couplable to a remote device such as server system 122. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to user 401 via media output component 415 and, optionally, receiving and processing input from input device 420. A user interface may include, among other possibilities, a web browser and client application. Web browsers enable users, such as user 401, to display and interact with media and other information typically embedded on a web page or a website from server system 122. A client application allows user 401 to interact with a server application from server system 122.

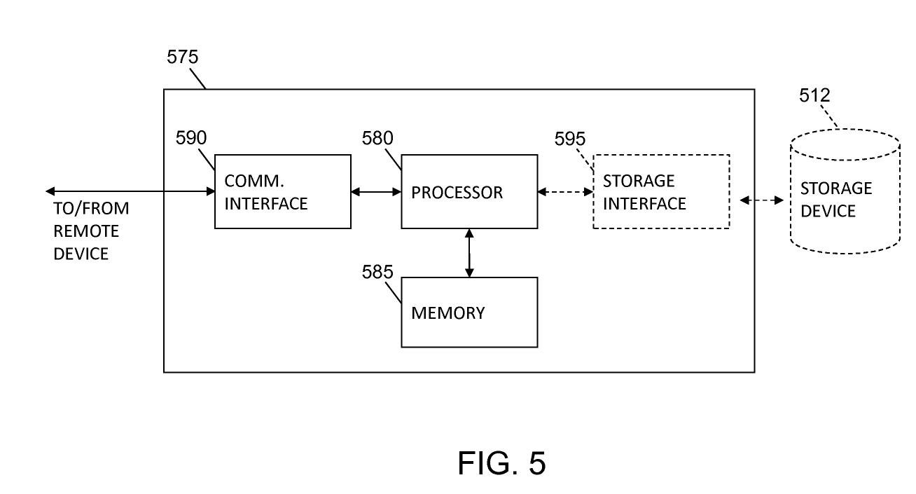

FIG. 5 illustrates an example configuration of a server computing device 575 such as server system 122 (shown in FIGS. 1-3). Server computing device 575 may include, but is not limited to, database server 204, application server 302, web server 304, fax server 306, directory server 308, and mail server 310.

Server computing device 575 includes a processor 580 for executing instructions. Instructions may be stored in a memory area 585, for example. Processor 580 may include one or more processing units (e.g., in a multi-core configuration).

Processor 580 is operatively coupled to a communication interface 590 such that server computing device 575 is capable of communicating with a remote device such as client computing device 402 or another server computing device 575. For example, communication interface 590 may receive requests from client computing devices 202 via the Internet, as illustrated in FIGS. 1-3.

Processor 580 may also be operatively coupled to a storage device 512. Storage device 512 is any computer-operated hardware suitable for storing and/or retrieving data. In some embodiments, storage device 512 is integrated in server computing device 575. For example, server computing device 575 may include one or more hard disk drives as storage device 512. In other embodiments, storage device 512 is external to server computing device 575 and may be accessed by a plurality of server computing devices 575. For example, storage device 512 may include multiple storage units such as hard disks or solid state disks in a redundant array of inexpensive disks (RAID) configuration. Storage device 512 may include a storage area network (SAN) and/or a network attached storage (NAS) system.

In some embodiments, processor 580 is operatively coupled to storage device 512 via a storage interface 595. Storage interface 595 is any component capable of providing processor 580 with access to storage device 512. Storage interface 595 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 580 with access to storage device 512.

Memory areas 410 and 585 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

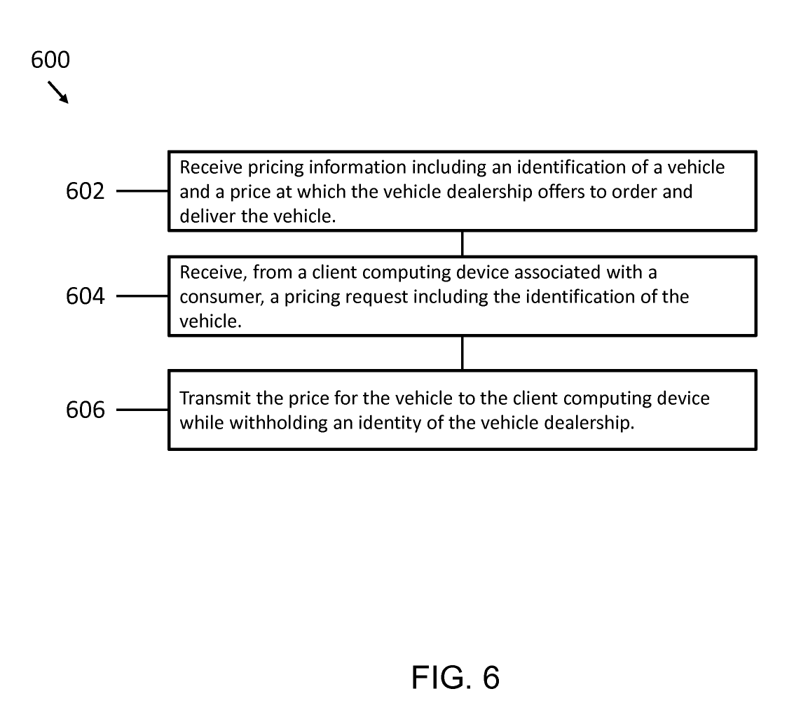

FIG. 6 is a flowchart of an example process 600 that may be performed by one or more computing devices (e.g., server computing device 122) of pricing information system 200. Initially, server computing device 122 receives 602 pricing information 124 including a price at which a vehicle dealership (e.g. vehicle dealership 112) offers to order and deliver a vehicle (e.g., vehicle 110). Additionally, server computing device 122 receives 604 a pricing request 128 including an identification (e.g., identification 111) of the vehicle (e.g., vehicle 110) from a client computing device (e.g., client computing device 104) associated with a consumer (e.g., consumer 102). Additionally, server computing device 122 transmits 606 the price for the vehicle (e.g., vehicle 110) to client computing device 104 while withholding an identity (e.g., identity 113) of the vehicle dealership (e.g., vehicle dealership 112).

In some implementations, the price received in pricing information 124 is a first price, and server computing device 122 also receives pricing information 126 from client computing device 118 associated with vehicle dealership 116, including a second price for ordering and delivering vehicle 110. In such implementations, server computing device 122 determines a lowest price among the first price and the second price and transmits the lowest price to client computing device 104.

In some implementations, server computing device 122 stores the identities 113 and 117 of vehicle dealerships (e.g., vehicle dealership 112 and vehicle dealership 116), identifications (e.g., make, model, and features and/or VINs) of vehicles (e.g., vehicle 110), and pricing information (e.g., pricing information 124 and 126) in database 206.

In some implementations, server computing device 122 compares a first location (e.g., address included in identity 113) associated with a vehicle dealership (e.g., vehicle dealership 112) to a second location associated with client computing device 104, and determines that the first location is within a predetermined distance of the second location. In other words, server computing device 122 determines, for example, that vehicle dealership 112 is within local market 120, prior to transmitting any of pricing information 124 from vehicle dealership 112 to client computing device 104.

In some implementations, prior to transmitting the price in response 130, server computing device 122 receives payment information from client computing device 104 to be applied to a fee for transmitting the price. For example, the payment information may be included in pricing request 128.

In some implementations, server computing device 122 is configured such that transmitting the price to client computing device 104 additionally includes transmitting a price difference between the price and a dealer invoice or MSRP for vehicle 110.

In some implementations, server computing device 122 receives, from client computing device 104, payment information for a deposit to be applied, at least in part, to the price for vehicle 110 and, in response to receiving the payment information, transmits identity 113 of vehicle dealership 112 to client computing device 104. In some implementations, server computing device 122 transmits communication 134 including a notification to vehicle dealership 112 that the deposit has been received. Additionally, in some implementations, server computing device 122 receives a confirmation message from at least one of client computing device 104 and vehicle dealership 112 (i.e., from client computing device 114) that vehicle dealership 112 has delivered vehicle 110 to consumer 102. In some implementations, server computing device 122 transmits payment information to vehicle dealership 112 (i.e., to client computing device 114) to apply at least a portion of the deposit to the price.

In some implementations, server system 122 receives a confirmation message from each of vehicle dealerships 112 and 116 (i.e., from client computing devices 114 and 118) confirming that vehicle dealerships 112 and 116 will not require that a consumer finance the vehicle, trade in a vehicle, or purchase any features (“options”) that are not provided by the manufacturer. More specifically, the confirmation message confirms that the price offered by the vehicle dealerships 112 and 116 is a final price.

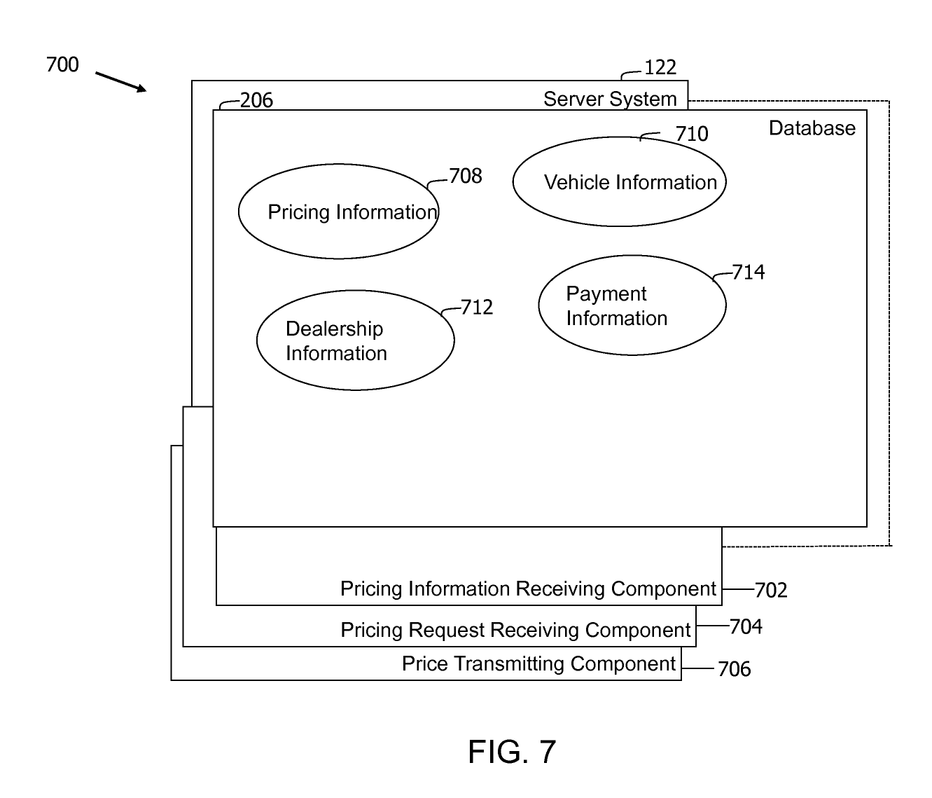

FIG. 7 is a diagram 700 of components of one or more example computing devices that may be used in server system 122. FIG. 7 further shows a configuration of database 206 (FIG. 2). Database 206 is coupled to several separate components within server system 122, which perform specific tasks.

Server system 122 includes a pricing information receiving component 702 for receiving pricing information from at least one vehicle dealership, such as vehicle dealership 112. Server system 122 also includes a pricing request receiving component 704 for receiving a pricing request (e.g., pricing request 128) for a vehicle, such as vehicle 110, from a client computing device (e.g. client computing device 104). Additionally, server system 122 includes a price transmitting component 706 for transmitting a price of the vehicle (e.g., vehicle 110) to the client computing device (e.g., client computing device 104), while withholding identity 113 of vehicle dealership 112.

In an example embodiment, database 206 is divided into a plurality of sections, including but not limited to, a pricing information section 708, a vehicle information section 710, a dealership information section 712, and a payment information section 714. Pricing information section 708 includes, for example, a price transmitted by client computing device 114 of vehicle dealership 112 for ordering and delivering vehicle 110, and a price transmitted by client computing device 118 of vehicle dealership 116 for ordering and delivering vehicle 110. Vehicle information section 710 includes, for example, makes, models, features, and VINs (i.e., identities) of vehicles, including vehicle 110. Dealership information section 712 includes identity information (e.g., name, address, phone number) for vehicle dealerships, including, for example, identity 113 of vehicle dealership 112 and identity 117 of vehicle dealership 116. Payment information section 714 includes information required to transfer funds from one financial account to another financial account. Accordingly, payment information section 714 may include bank account identification numbers, routing numbers, transaction amounts, credit card numbers, debit card numbers, and/or other information required to transfer funds between financial accounts. These sections within database 206 are interconnected to retrieve and store information in accordance with the functions and processes described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 405, 580, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for providing pricing information for ordering a vehicle, the method is performed by a server computing device, the method comprising:
receiving, by the server computing device, pricing information including an identification of the vehicle and a price at which a vehicle dealership offers to order and deliver the vehicle;
receiving, by the server computing device, from a client computing device associated with a consumer, a pricing request including the identification of the vehicle; and
transmitting the price for the vehicle to the client computing device while withholding an identity of the vehicle dealership.

2. The method of claim 1, wherein the vehicle dealership is a first vehicle dealership of a plurality of vehicle dealerships that includes at least a second vehicle dealership, the pricing information is first pricing information, and the price is a first price, said method further comprising:
receiving, by the server computing device, at least second pricing information for the vehicle, including a second price at which the second vehicle dealership offers to order and deliver the vehicle;
determining a lowest price of at least the first price and the second price; and
transmitting the lowest price to the client computing device.

3. The method of claim 1, wherein the server computing device is coupled to a database, said method further comprising storing the identity of the vehicle dealership, a location of the vehicle dealership, the identification of the vehicle, and the pricing information in the database.

4. The method of claim 1, further comprising:
comparing a first location associated with the vehicle dealership to a second location associated with the client computing device; and
determining that the first location is within a predetermined distance of the second location,
wherein transmitting the price further comprises transmitting the first price to the client computing device based upon the determination.

5. The method of claim 1, further comprising:
prior to transmitting the price to the client computing device, receiving payment information from the client computing device to be applied to a fee for transmitting the price.

6. The method of claim 1, wherein transmitting the price further comprises transmitting a price difference between the first price and at least one of a dealer invoice and a manufacturer suggested retail price (MSRP) for the vehicle.

7. The method of claim 1, further comprising:
receiving, by the server computing device from the client computing device, payment information for a deposit to be applied, at least in part, to the price; and
in response to receiving the payment information, transmitting the identity of the vehicle dealership to the client computing device.

8. The method of claim 7, further comprising transmitting a notification to the vehicle dealership that the deposit has been received.

9. The method of claim 7, further comprising receiving a confirmation message that the vehicle dealership has delivered the vehicle to the consumer.

10. The method of claim 7, wherein the payment information is first payment information, said method further comprising transmitting second payment information to the vehicle dealership to apply at least a portion of the deposit to the price.

11. A server computing device for providing pricing information for ordering a vehicle, said server computing device configured to:
receive pricing information including an identification of the vehicle and a price at which a vehicle dealership offers to order and deliver the vehicle;
receive, from a client computing device associated with a consumer, a pricing request including the identification of the vehicle; and
transmit the price for the vehicle to the client computing device while withholding an identity of the vehicle dealership.

12. The server computing device of claim 11, wherein the vehicle dealership is a first vehicle dealership of a plurality of vehicle dealerships that includes at least a second vehicle dealership, the pricing information is first pricing information, and the price is a first price, said server computing device further configured to:
receive at least second pricing information for the vehicle, including a second price at which the second vehicle dealership offers to order and deliver the vehicle;
determine a lowest price of at least the first price and the second price; and
transmit the lowest price to the client computing device

13. The server computing device of claim 11, wherein said server computing device is coupled to a database, said server computing device is further configured to store the identity of the vehicle dealership, a location of the vehicle dealership, the identification of the vehicle, and the pricing information in the database.

14. The server computing device of claim 11, further configured to:
compare a first location associated with the vehicle dealership to a second location associated with the client computing device; and
determine that the first location is within a predetermined distance of the second location,
wherein said server computing device is further configured such that transmitting the price further comprises transmitting the price to the client computing device based upon the determination.

15. The server computing device of claim 11, further configured to receive first payment information from the client computing device to be applied to a fee for transmitting the price, prior to transmitting the price to the client computing device.

16. The server computing device of claim 11, further configured such that transmitting the price further comprises transmitting a price difference between the price and at least one of a dealer invoice and a manufacturer suggested retail price (MSRP).

17. The server computing device of claim 11, further configured to:
receive, from the client computing device, payment information for a deposit to be applied, at least in part, to the price; and
in response to receiving the payment information, transmit the identity of the vehicle dealership to the client computing device.

18. The server computing device of claim 17, further configured to transmit a notification to the vehicle dealership that the deposit has been received.

19. A computer-readable storage device having processor-executable instructions embodied thereon, for providing pricing information for ordering a vehicle, wherein when executed by a server computing device, the processor-executable instructions cause the server computing device to:
receive pricing information including an identification of the vehicle and a price at which a vehicle dealership offers to order and deliver the vehicle;
receive, from a client computing device associated with a consumer, a pricing request including the identification of the vehicle; and
transmit the price for the vehicle to the client computing device while withholding an identity of the vehicle dealership.

20. The computer-readable storage device of claim 19, wherein said processor-executable instructions further cause the server computing device to:
receive, from the client computing device, payment information for a deposit to be applied, at least in part, to the price; and
in response to receiving the payment information, transmit the identity of the vehicle dealership to the client computing device.
